(19) United States
(12) Patent Application Publication
(10) Pub. No.: US 2022/0100938 A1
(43) Pub. Date: Mar. 31, 2022

(54) Flexible Cell Height Layout Architecture

(71) Applicant: Taiwan Semiconductor Manufacturing Company Limited, Hsinchu (TW)

(72) Inventor: Guru Prasad, Austin, TX (US)

(21) Appl. No.: 17/035,951

(22) Filed: Sep. 29, 2020

(51) Int. Cl. G06F 30/337; H01L 27/02; G06F 30/392

(52) U.S. Cl. CPC G06F 30/337; G06F 30/392; H01L 27/0207

(57) ABSTRACT

Systems and methods are described for optimized cell placement. A plurality of cells arranged in an area. Each cell includes a first cell region and a second cell region. The first cell region abuts the second cell region at a reference edge. The cells are aligned such that each reference edge horizontally aligns with a placement reference edge of a row having multiple cells.

### FIELD

The technology described in this disclosure relates generally to device layouts and more particularly to flexible cell heights for device layouts and the method to optimize the placement of these types of cells by the EDA tools.

### BACKGROUND

Electronic Design Automation (EDA) and related tools enable efficient design of complex integrated circuits which may have extremely large numbers of components (e.g., thousands, millions, billions, or more). Specifying characteristics and placement of all of those components (e.g., transistor arrangements to implement desired logic, types of transistors, signal routing) by hand would be extremely time consuming and expensive for modern integrated circuits, if not impossible. Modern EDA tools utilize cells to facilitate circuit design at different levels of abstraction. A cell in the context of EDA is an abstract representation of a component within a schematic diagram or physical device layout of an electronic circuit in software. Circuits may be designed at a logical layer of abstraction using cells, where those circuits may then be implemented using lower level specifications (e.g., transistor arrangement, signal routing) associated with those cells. Standard libraries are used to design electronic circuits, enabling power-performance-area (PPA) optimization.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram depicting an exemplary electronic circuit design engine in accordance with various embodiments of the present disclosure.

FIG. 2 is a block diagram depicting exemplary modules of a circuit design engine in accordance with various embodiments of the present disclosure.

FIG. 3 illustrates an exemplary cell having a reference edge in accordance with various embodiments of the present disclosure.

FIG. 4 illustrates another exemplary cell having a reference edge along with the power supply related pins in accordance with various embodiments of the present disclosure.

FIG. 5A illustrates another exemplary cell having planar transistors implemented within the cell in accordance with various embodiments of the present disclosure.

FIG. 5B illustrates another exemplary cell having FinFet transistors implemented within the cell in accordance with various embodiments of the present disclosure.

FIG. 6 illustrates another exemplary cell illustrating vertical cell height in accordance with various embodiments of the present disclosure.

FIG. 7 illustrates incremental cell heights in accordance with various embodiments of the present disclosure.

FIG. 8 illustrates exemplary cells having skewed N and P device sizes in accordance with various embodiments of the present disclosure.

FIG. 9 illustrates exemplary cells having fractional N and P device sizes in accordance with various embodiments of the present disclosure.

FIG. 10 illustrates an example device layout having a plurality of cells in accordance with various embodiments of the present disclosure.

FIG. 11 illustrates another example device layout having a plurality of cells in accordance with various embodiments of the present disclosure.

FIG. 12 is an exemplary flow chart illustrating a method for generating a device layout such as those in FIGS. 10-11 in accordance with various embodiments of the present disclosure.

FIG. 13 is an exemplary flow chart illustrating a method of placing cells from a standard cell library that are instantiated in a design in accordance with various embodiments of the present disclosure.

FIG. 14 is another exemplary flow chart illustrating a method of generating a library of standard cells in accordance with various embodiments of the present disclosure.

FIG. 15 is an exemplary block diagram illustrating a sample computing device architecture for implementing various aspects described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

An Integrated Circuit (IC) is a complex network of a very large number of components (e.g., transistors, resistors, and capacitors) interconnected using the features of a process technology to realize a desired function. Manually designing such a component is typically not feasible because of the number of steps involved and the amount of design information that needs to be processed. EDA tools may be used to assist the designers in this process. Due to the size and complex nature of the design process, the IC may be designed using a hierarchical approach where the design is broken down in smaller pieces which are assembled to form the complete chip. This process also helps in pre-designing commonly used sub-blocks and reusing them where needed. A standard cell library is one such collection of basic components (e.g., AND, OR, NAND, NOR, XOR, Flip-flops, Latches) that is commonly used by certain EDA tools to automate the generation of device layouts from a behavioral description of a block. Each piece of design may have an abstract representation for the various information that is needed to capture the design such as functional behavior, circuit description, physical device layout, timing behavior, many of which are used by the EDA tools to assist in the design process.

EDA tools may use a library of standard cells associated with common circuit functions. For example, standard cells can be associated logic gates, such as an AND gate, an OR gate, an XOR gate, a NOT gate, a NAND gate, a NOR gate, and an XNOR gate, and circuits such as a multiplexer, a flip-flop, an adder, and a counter. Those standard cells can be arranged to realize more complex integrated circuit functions. The cells are placed in rows such that a reference edge within each cell is aligned to a placement reference edge in the row with minimal to no overlaps between cells allowing for cells with different heights to be placed in the same design. When designing an integrated circuit having specific functions, standard cells may be selected. Next, designers, EDA software, and/or Electronic Computer-Aided Design (ECAD) tools draw out device layouts of the integrated circuit including the selected standard cells and/or non-standard cells. The device layouts may be converted to photomasks. Then, semiconductor integrated circuits can be manufactured, when patterns of various layers, defined by the photomasks, are transferred to a substrate.

Systems and methods are provided herein that include a device layout architecture for standard cell libraries. These standard cell libraries which allow for varying cell heights are not limited to an integral multiple of a single standard height. The subject matter provided herein also includes standard cells with asymmetrical heights for P and N devices and also cells with height lesser than the standard height resulting in a high degree of flexibility to optimize the device layout of each cell in the library for area, performance and/or power. This flexible cell height architecture is made possible by establishing a reference edge at the intersection of the N-well and P-well of each cell in the library and a placement engine such as an EDA tool places the cells so as to align these reference edges to a corresponding alignment line in the placement rows and resolving the overlaps resulting in a puzzle fit cell placement.

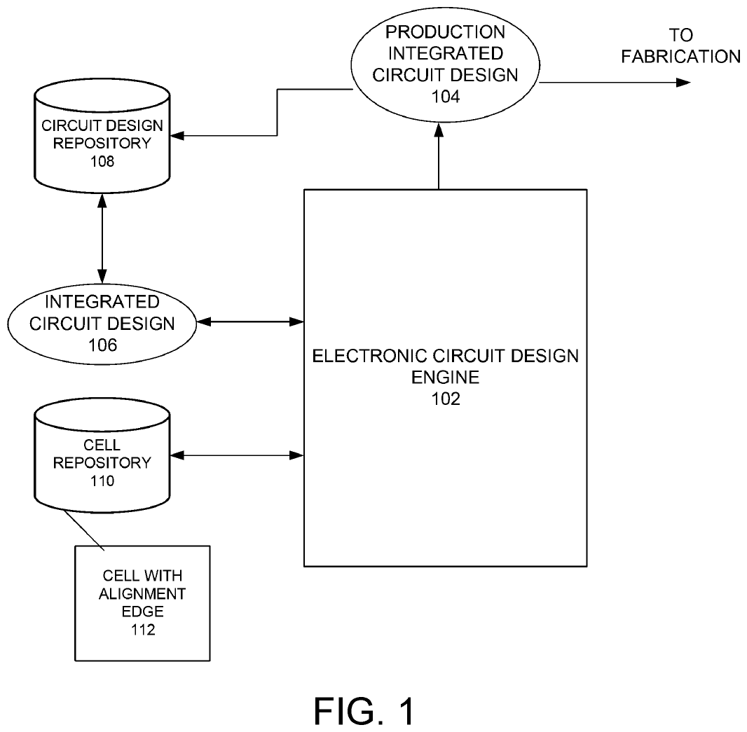

FIG. 1 is a block diagram depicting an electronic circuit design engine according to an exemplary embodiment. The electronic circuit design engine 102 facilitates development of a production integrated circuit design 104 that is used in the fabrication of a physical integrated circuit. The circuit design engine 102 receives or facilitates initial generation of an integrated circuit design 106 that may be developed (e.g., over a number of iterative revisions) and stored in a non-transitory circuit design repository 108, such as via interactions with a user interface or execution of automated scripts. For example, on request, the circuit design engine 102 may access or receive the integrated circuit design 106 in the form of a computer file, perform operations on the integrated circuit design 106, and then output a modified form of the design (e.g., as an integrated circuit design 106 file for storage in the design repository 108 or as a production integrated circuit design 104 (e.g., in the form of an EDA file, a netlist) for fabrication). The circuit design 106 may be made up of a plurality of components (e.g., resistors, capacitors, transistors logic gates, data signal lines), some or all of which take the form of cells. The integrated circuit design 106 may take a variety of forms, such as a behavioral model of a design in a register-transfer level (RTL) representation or a more hardware specific specification, such as a netlist. The circuit design engine 102 is responsive to one or more cell repositories (e.g., cell repository 110) that store data associated with cells that can be used as building blocks in the generation of integrated circuit designs 104, 106. Such cells can include standard cells that may take a variety of forms and represent a variety of functions (e.g., the operation of one or more logic gates), such as cells with varying heights which may not be a multiple of a standard single cell row height and having a reference edge at the intersection of the N-well and P-well.

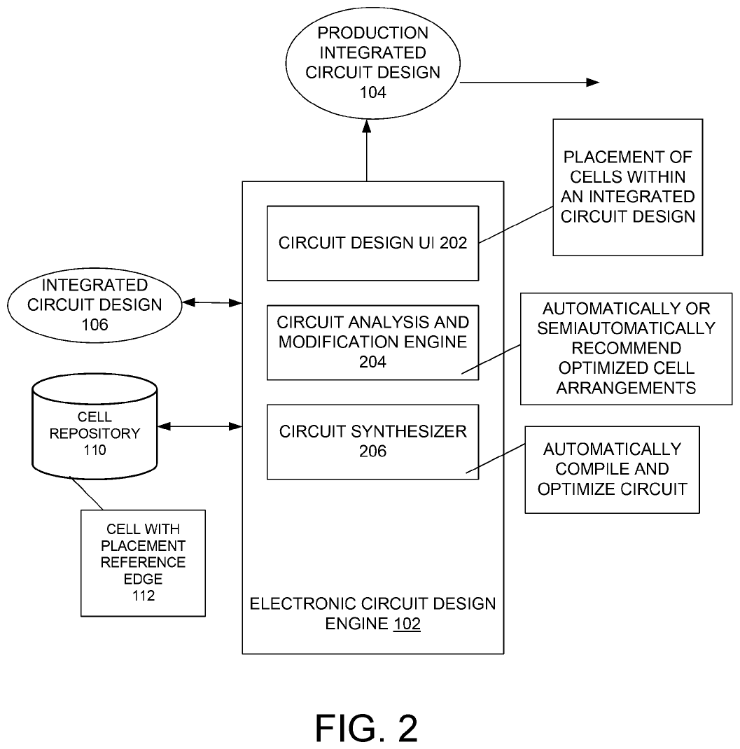

Electronic circuit design engines may provide a variety of different circuit design functionality. FIG. 2 is a block diagram depicting modules of a circuit design engine according to an exemplary embodiment. An electronic circuit design engine 102 receives an integrated circuit design 106 via a file or commands that dictate the content of that design 106 entered via a mechanism such as a circuit design user interface 202. The interface 202 may display graphics or text describing an integrated circuit design and provide commands for building and manipulating the design. The circuit design engine 102 is further responsive to a cell repository 110 that stores cell data records like the one depicted at 112 with varying heights which may not a multiple of a standard single cell row height and with the reference edge at the intersection of the N-well and P-well. The circuit design user interface 202 can provide controls for accessing standard cells from the repository 110 and integrating them into an integrated circuit design 106. Upon completion of an IC design 106, the design may be output from the engine 102 at 106 for saving in a non-transitory computer readable medium or as a production integrated circuit design 104 for fabrication of an integrated circuit.

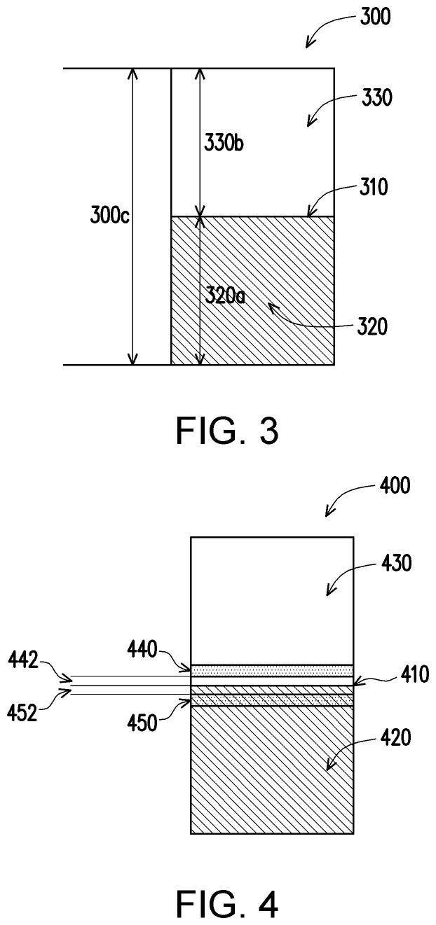

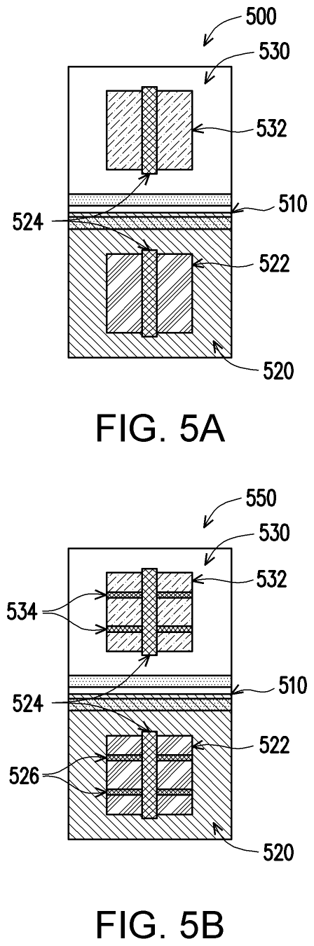

FIG. 3 illustrates an exemplary cell 300 having a reference edge 310 in accordance with various embodiments of the present disclosure. A cell 300 includes a P-well region 320 and an N-well region 330. The reference edge 310 is defined at an edge where the P-well region 320 abut the N-well region 330. The reference edge 310, as described in more detail in FIG. 4, may be used to define standard locations of device layout objects that align when multiple such cells of varying heights are placed together. One example of these types of device layout objects could be between the power and ground rails, as described in more detail in FIG. 4. A complete standard cell device layout can include active P-devices and/or N-devices within the N-well and P-well regions respectively, interconnected using various interconnect metal layers to realize a desired logic function, as described in more detail in FIG. 5A-5B. These N-device and P-devices can be, for example, planar transistors, FinFet transistors, and/or other types of devices, as illustrated in FIG. 5A-5B. A taller N-well can accommodate a wider channel width P-device and similarly, a taller P-well can accommodate a wider channel N-device. In both cases, resulting in higher drive strength and hence performance. In the example illustrated in FIG. 3, the reference edge 310 is defined at the edges where the P-well region 320 and the N-well region 330 abut. The P-well region 320 and N-well region 330, in this example, are of the same or substantially similar height. A height 320a of the P-well region 320 is defined in a vertical direction relative to the reference edge 310. A height 330b of the N-well region 330 is defined in a vertical direction relative to the reference edge 310. The cell height 300c is defined by a combination of the height 320a of the P-well region 320 and the height 330b of the N-well region 330. The cell height 300c can be unique to each cell depending upon the individual heights of the N-well and the P-well, enabling varying cell heights for the different cells in the standard cell library. This flexibility in choosing the cell height for each cell in the standard cell library can facilitate better optimization of the device layout for power, performance, and area.

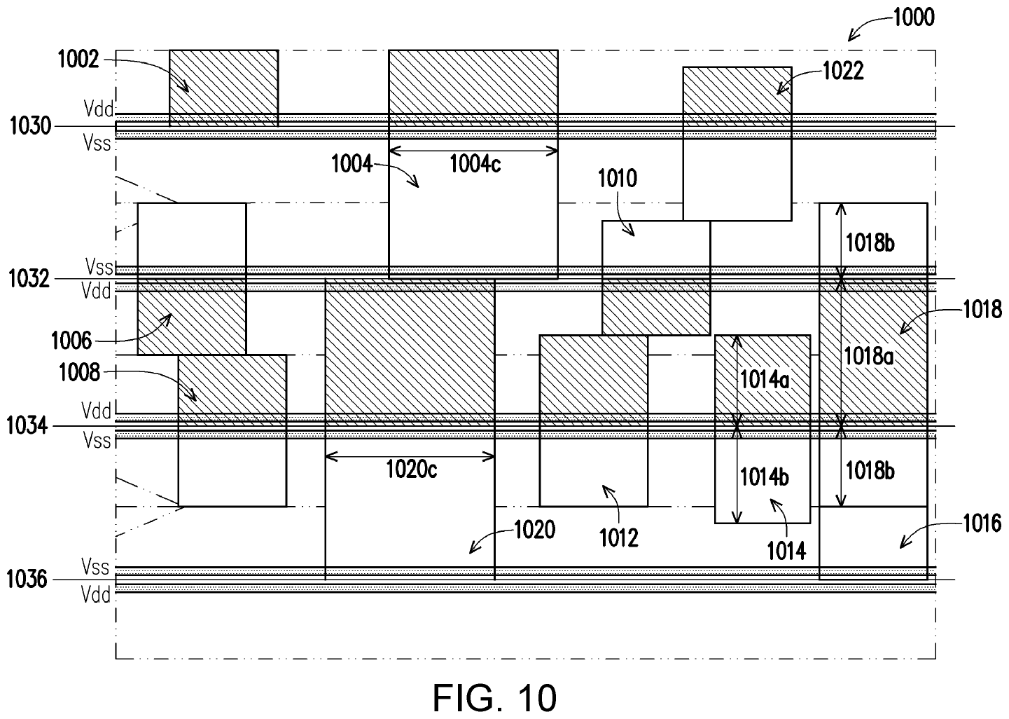

FIG. 4 illustrates another exemplary cell 400 having a reference edge 410 along with the power supply related pins in accordance with various embodiments of the present disclosure. The reference edge 410 is defined at an edge of P-well 420 that abuts N-well 430. The P-well 420 extends vertically downwards from the reference edge 410. Similarly, the N-well 430 extends vertically upwards from the reference edge 410. The reference edge 410 is between power and ground rails 450,440, respectively, within cell 400. The power rail 450 can be a set distance 452 measured relative to the reference edge 410. Similarly, the ground rail 440 can be a set distance 442 measured relative to reference edge 410. In some embodiments, the set distances 442, 452 can be substantially similar or equal. An EDA tool places cells such as cell 400 within a device layout such that the reference edge 410 of each cell in a placement row aligns with a corresponding alignment line in the row resulting in all of the power and ground rails of the cells also aligning as described in more detail in FIG. 10.

FIG. 5A illustrates another exemplary cell 500 having planar transistors implemented within the cell 500 in accordance with various embodiments of the present disclosure. The reference edge 510 is defined at an edge of P-well 520 that abuts N-well 530. The P-well 520 extends vertically downwards form the reference edge 510. The P-well 520 can include an N-device 522 such as an NMOS planar transistor. Similarly, the N-well 530 extends vertically upwards from the reference edge 510. The N-well 530 can include a P-device 532 such as a PMOS planar transistor. Both P-well 520 and N-well 530 can include polysilicon gate and interconnects 524.

FIG. 5B illustrates another exemplary cell 550 having FinFet transistors implemented within the cell 550 in accordance with various embodiments of the present disclosure. In this example embodiment, P-device 532 can include one or more fins 534. Similarly, N-device 522 can include one or more fins 526.

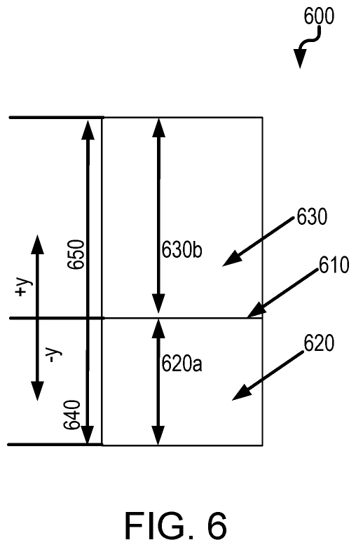

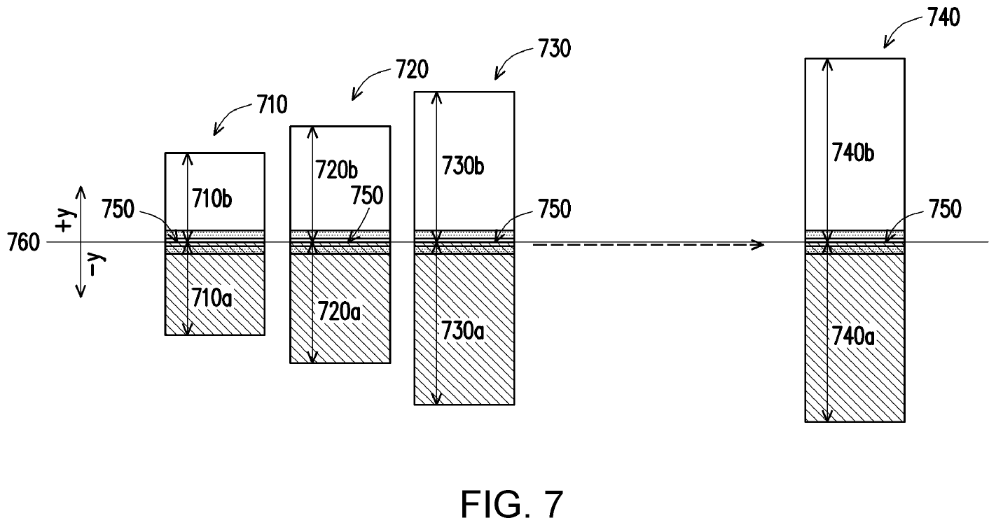

FIG. 6 illustrates another exemplary cell 600 illustrating vertical cell height in accordance with various embodiments of the present disclosure. As explained in FIGS. 3-4, the reference edge 610 is defined at an edge of N-well 620 that abuts with an edge of P-well 630. The N-well 620 can extend vertically in the negative y-direction 640 relative to the reference edge 610. Similarly, the P-well 630 can extend vertically in the positive y-direction 650 relative to the reference edge 610. The height 620a of N-well 620 and the height 630b of P-well 630 are unrestricted and can reach a desired cell height. For example, FIG. 7 illustrates incremental cell heights in accordance with various embodiments of the present disclosure. In the embodiment illustrated in FIG. 7, each cell 710, 720, 730, 740 has a height that is defined by a combination of corresponding heights of an N-well and P-well. The N-well and P-well for each cell is of a substantially similar or equal height. For example, cell 710 can have an N-well height 710a that extends in the negative y-direction relative to a reference edge 750. Similarly, cell 710 can have a P-well that is of a substantially similar or equal height 710b to the N-well height 710a. In another example, cell 720 can have an N-well height 720a that extends in the negative y-direction relative to a reference edge 750. Similarly, cell 720 can have a P-well that is of a substantially similar or equal height 720b to the N-well height 710a. The N-well height 720a of cell 720 can be greater than the N-well height 710a of cell 710. Cell 730 and 740 also have N-well heights 730a, 740a, respectively, that each are greater than the preceding cell. The corresponding P-well cell heights 730b,740b can be of similar or equal height to that of N-well heights 730a, 740a, respectively. By way of example and for ease of understanding, cells 710, 720, 730, 740 are described as having a vertically aligned reference edge 750. In other words, an EDA tool can use the reference edge 750 of each cell 710, 720, 730, 740 to align the cells together along a placement reference edge 760 (e.g., where y equals 0). In other words, the reference edges 750 are all placed along the placement reference edge 760 illustrated in FIG. 7.

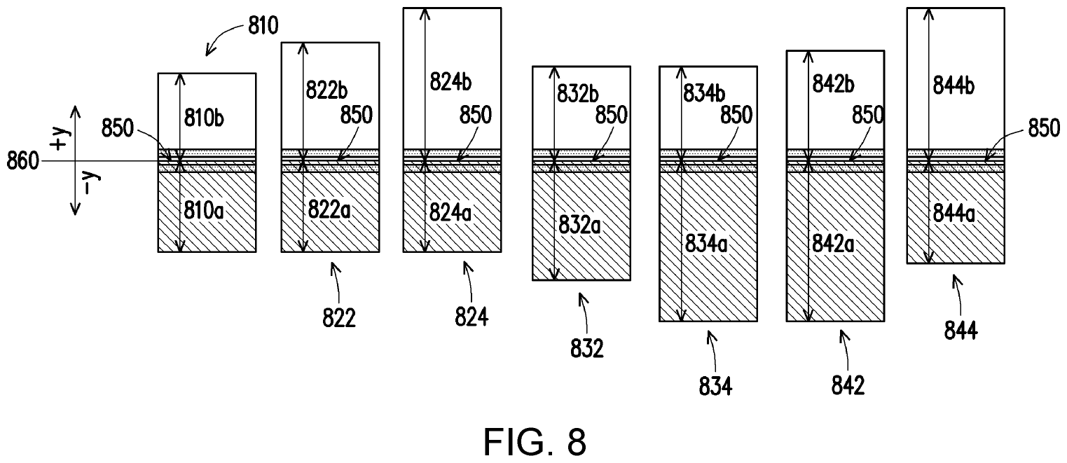

FIG. 8 illustrates exemplary cells 810, 822, 824, 832, 834, 842, 844 having skewed N and P device sizes in accordance with various embodiments of the present disclosure. By way of example and for ease of understanding, cell 810 is provided as a reference with an N-well 810a and P-well height 810b that are equal or substantially similar to each other in height. Cell 810 has height defined by the combination of an N-well height 810a and a P-well height 810b. In some embodiments, cell 822 and cell 824 have varying P-well heights that are greater than the corresponding N-well heights of the same cell (e.g., skewed P-well). For example, cell 822 has a total cell height that is defined by the combination of an N-well height 822a and a P-well height 822b. Cell 824 has a total cell height that is defined by the combination of an N-well height 824a and a P-well height 824b. Both N-well height 822a and N-well height 824a are each substantially similar or equal to N-well height 810a. In one example, the P-well height 822b is greater than each of the N-well height 822a and P-well height 810b. In another skewed N-well example, the P-well height 824b is greater than each of the N-well height 824a, the P-well height 822b, and the P-well height 810b.

In some embodiments, cell 832 and cell 834 have varying N-well heights that are greater than the corresponding P-well heights of the same cell (e.g., skewed N-well). For example, cell 832 has a total cell height that is defined by the combination of an N-well height 832a and a P-well height 832b. Cell 834 has a total cell height that is defined by the combination of an N-well height 834a and a P-well height 834b. Both P-well height 832b and P-well height 834b are each substantially similar or equal to P-well height 810b. In one example, the N-well height 832a is greater than each of the P-well height 832b and N-well height 810a. In another skewed N-well example, the N-well height 834a is greater than each of the P-well height 834b, the N-well height 832a, and the N-well height 810a.

In some embodiments, cell 842 and cell 844 have both varying N-well heights and P-well heights relative to the reference cell 810 (e.g., skewed N-well and P-well). For example, cell 842 has a total cell height that is defined by the combination of an N-well height 842a and a P-well height 842b. Cell 844 has a total cell height that is defined by the combination of an N-well height 844a and a P-well height 844b. Both P-well height 842b and P-well height 844b are each greater than P-well height 810b. In one example, the N-well height 842a and the P-well 842b vary in height relative to each other and to the N-well height 810a and the P-well 810b, respectively. Similarly, the N-well height 844a and the P-well height 844b vary in height relative to each other and to the N-well height 810a and the P-well height 810b,respectively. In each of the examples, the reference edge 850 is vertically aligned with placement reference edge 860 for each of cells 810, 822, 824, 832, 834, 842, 844.

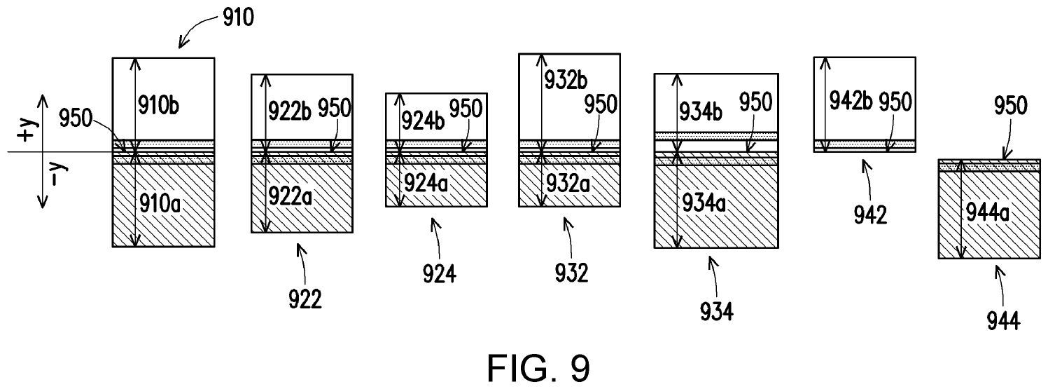

FIG. 9 illustrates exemplary cells 910, 922, 924, 932, 934, 942, 944 having fractional N and P device sizes in accordance with various embodiments of the present disclosure. By way of example and for ease of understanding, cell 910 is provided as a reference with an N-well height 910a and P-well height 910b that are equal or substantially similar to each other. Cell 910 has cell height that is defined by the combination of an N-well height 910a and a P-well height 910b. In some embodiments, cell 922 and cell 924 have symmetrical, fractional heights of N-well height 922a and P-well height 924b. For example, cell 922 has a total cell height that is defined by the combination of an N-well height 922a and a P-well height 922b, which are approximately equal in height (e.g., symmetrical about the reference edge 950). Cell 924 has a total cell height that is defined by the combination of an N-well height 924a and a P-well height 924b, which are equal in height to each other (e.g., symmetrical about the reference edge 950). The total cell height of cell 922 and the total cell height of cell 924 are each a fraction of that of the total cell height of cell 910.

In some embodiments, cell 932 and cell 934 have varying N-well and P-well heights that are fractional (e.g., skewed N-well/P-well fractional). For example, cell 932 has a total cell height that is defined by the combination of an N-well height 932a and a P-well height 932b. Similar to cell 832, in one embodiment, the P-well height 932b is of a substantially similar or equal height of P-well 910b. The P-well height 932b and N-well height 932a differ from each other. The N-well height 932a is a fraction of each of the N-well height 910a and the P-well 932b (e.g., skewed P fractional). In another embodiment, cell 934 has a total cell height that is defined by the combination of an N-well height 934a and a P-well height 934b. Both N-well height 934a and N-well height 910a are each substantially similar or equal to each other. The P-well height 934b is a fractional height relative to each of the N-well 934a and P-well 910b.

In some embodiments, cell 942 and cell 944 have only one of an N-well or a P-well. For example, cell 942 has a total cell height that is defined by a P-well height 942b. Cell 942 does not contain an N-well. Cell 944 has a total cell height that is defined by N-well height 944a.

FIG. 10 illustrates an example portion of a device layout 1000 having a plurality of cells in accordance with various embodiments of the present disclosure. As illustrated in FIG. 10, by placing the cells such that the reference edge of each cell aligns with a placement reference edge in each placement row with minimal to no overlap between cells, a dense placement of cell is possible. Such a device layout can facilitate an increased number of cells arranged within a given device layout area. The cells are placed throughout the portion of the device layout 1000 in a puzzle-like form so as to facilitate a maximum number of cells within the area. As illustrated in FIG. 10, the top and/or bottom edges of the cells may not be aligned within each other as the alignment occurs using the reference edge of each cell, rather than aligning the top and/or bottom edges.

The example portion of the device layout 1000 includes cell placement of a number of different cells types within a single library or multiple libraries, including but not limited to the various embodiments described in FIGS. 3-8. For example, the portion of the device layout 1000 can include any of the following cells or combination thereof: (i) a P-only cell 1002 having a P-well (e.g., similar to cell 944 of FIG. 9), (ii) a skewed N cell 1004 (e.g., cell 822 or 824 of FIG. 8), (iii) cells 1006, 1008 (e.g., similar to cell 600 of FIG. 7, cell 610 of FIG. 7, cell 810 of FIG. 8), (iv) a fractional height cell 1010 having equal N-well and P-well heights (e.g., similar to cell 922 or cell 924 of FIG. 9), a skewed P cell 1012 (e.g., cell 832 of FIG. 8 or 934 of FIG. 9), (v) an elongated cell 1014 (e.g., similar to cell 600 of FIG. 7, cell 610 of FIG. 7, cell 810 of FIG. 8, but with a greater cell height defined by the combination of N-well 1014a and P-well 1014b), (vi) an N-only cell 1016 having only an N-well (e.g., similar to cell 942 of FIG. 9), (vii) a split double height cell 1018 having an elongated N-well height 1018a and two P-wells split by the N-well, each P-well having a corresponding height 1018b, (viii) no-split double standard height cell 1020 (e.g., similar to cell 600 of FIG. 6, cell 610 of FIG. 7, cell 810 of FIG. 8, but with a cell height equal to double that of those cells), and/or (ix) a skewed P fractional cell 1022. As illustrated in

FIG. 10, in addition to having varying lengths as previously described, each cell can also have varying widths. For example, cell 1004 has a cell width 1004c that is wider than that of other cells in the portion of the device layout 1000. Similarly, cell 1020 has a cell width 1020c that is wider than that of other cells in the portion of the device layout 1000. As illustrated within FIG. 10, like well types (e.g., either P-wells or N-wells) are grouped between the placement reference edges. For example, multiple N-wells are grouped between placement reference edges 1030, 1032 and between placement reference edges 1034, 1036. Similarly, multiple P-wells are grouped between placement reference edges 1032, 1034 or above placement reference edge 1030. In other words, aligning the reference edges of each cell can facilitate the formation of a continuous alternating P-well and N-well pattern.

The orientation of the various cells in FIG. 10 is presented for ease of understanding. The portion of the device layout 1000 is one of many possible cell arrangements facilitated by the present disclosure. Additionally, each cell can have varying cell widths such as those illustrated by cell 1004. It can be appreciated that the cells can be placed in a number of different arrangements so as to optimize the design of the device layout for a particular purpose.

The portion of the device layout 1000 also includes a number of power and ground rails (e.g., Vdd, Vss). As illustrated in FIG. 10, the cells are aligned between the power and ground rails. For example, cells 1002, 1004, 1022 each have reference edges which are aligned with each other and between the power and ground rails along placement reference edge 1030. Cells 1006, 1010 each have reference edges which are aligned with each other and between the power and ground rails along placement reference edge 1032. Cells 1008, 1020, 1012, 1014 each have reference edges which are aligned with each other along placement reference edge 1034. Cell 1016 has a reference edge that is aligned between the power and ground rails using placement reference edge 1036.

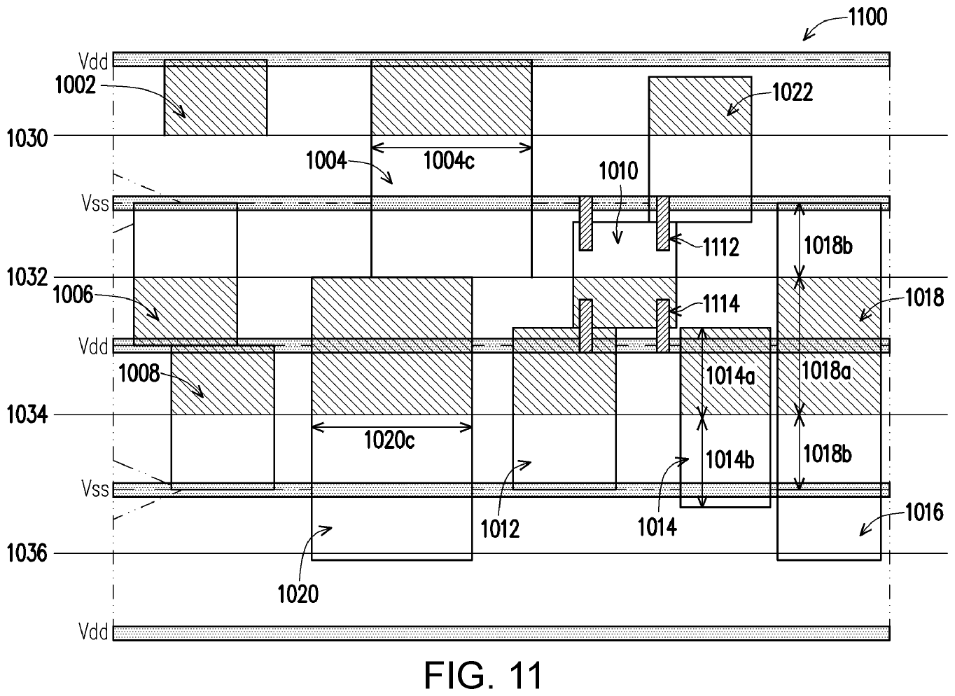

FIG. 11 illustrates another example device layout 1100 having a plurality of cells in accordance with various embodiments of the present disclosure. Power and ground rails (e.g., VDD, VSS) are farther spaced from the placement reference edge (e.g., placement reference edges 1030, 1032, 1034, 1036). Additionally, power pin extenders 1112, 1114 are used to establish power and ground connections to these fractional height cells since their boundary does not fully reach the power and ground rails.

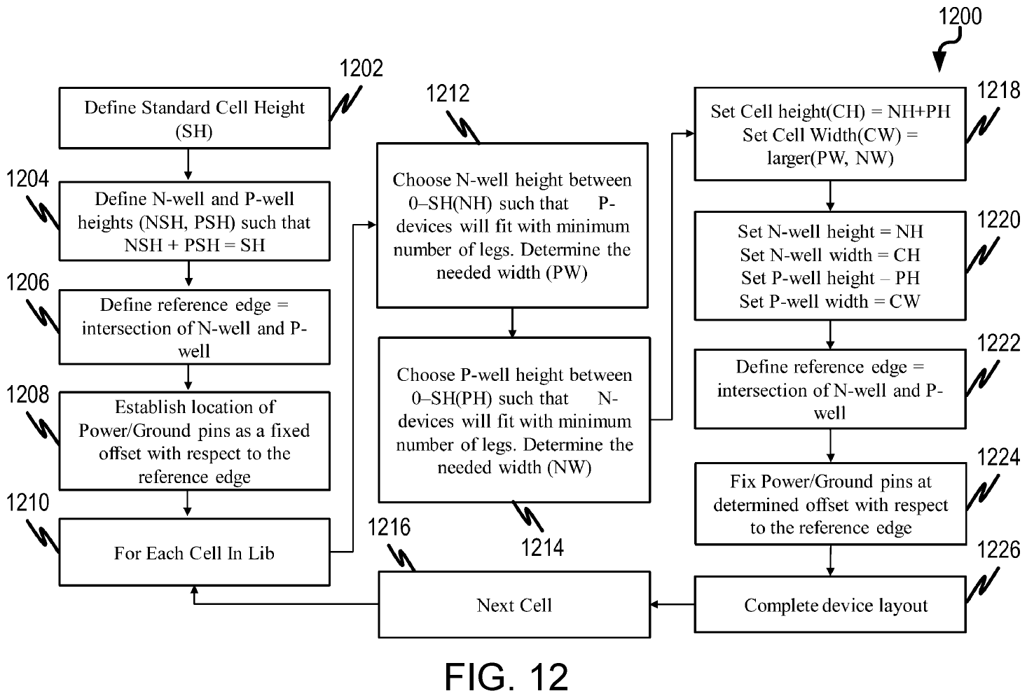

FIG. 12 is an exemplary flow chart 1200 illustrating a method for generating a device layout such as those in FIGS. 10-11 in accordance with various embodiments of the present disclosure. A standard cell height (SH) is defined within a cell library such as cell repository 1110 (e.g., step 1202). An N-well height (NSH) and P-well height (PSH) height are defined such that together the heights equal approximately the SH (e.g., step 1204). A reference edge is defined at the intersection of the N-well and P-well (e.g., step 1206). A location of power and ground rails are established as a fixed offset with respect to the reference edge (e.g., step 1208). Steps 1202-1208 are repeated for all cells within the cell library (e.g., step 1210). An N-well height (NSH) is chosen such that the P-devices can fit within a minimum number of legs and an appropriate width (PW) (e.g., step 1212). A P-well height (PSH) is chosen such that N-devices fit within a minimum number of legs and an appropriate width (NW) (e.g., 1214). A cell height (CH) is set as the combination of the NSH and PSH and the cell width is set to the larger of the PW or NW (e.g., step 1218). The N-well height and width and the P-well height and width are set within the cell library (e.g., 1220). A reference edge is set at the intersection of the N-well and P-well (e.g., step 1222). Power and ground pins are created at the predetermined offsets from the reference edge (e.g., step 1224). The layout in completed by placing the N and P devices within the P-Well and N-Well, respectively, and routing the interconnections (e.g., step 1226). This method iterates through each cell within the cell library (e.g., step 1216).

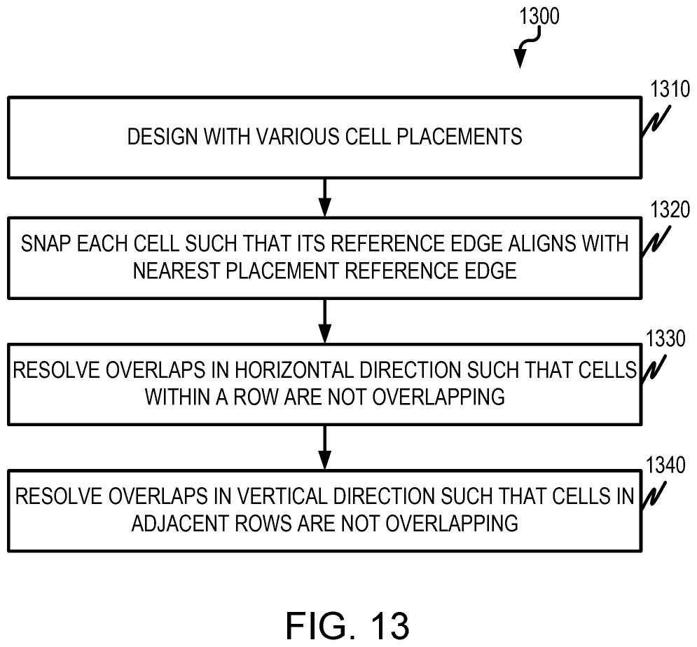

FIG. 13 is an exemplary flow chart 1300 illustrating a method of placing cells from a standard cell library that are instantiated in a design in accordance with various embodiments of the present disclosure. A design floorplan is filled with cells placed in horizontal rows (e.g., step 1310). A placement reference edge is within each row corresponding to the reference edge in the standard cells. At any stage in the design flow when cell placement is performed, each cell in the design is displaced vertically such that the reference edge in it aligns with the nearest placement reference edge in the floorplan (e.g., step 1320). Any overlaps in the horizontal direction within each row is resolved by displacing the overlapping cells (e.g., step 1330). Similarly any overlaps in the vertical direction between cells in adjacent rows are resolved by displacing the overlapping cells (e.g., step1340). This results in placement of the cells in a puzzle fit manner within a device layout as shown in FIG. 10.

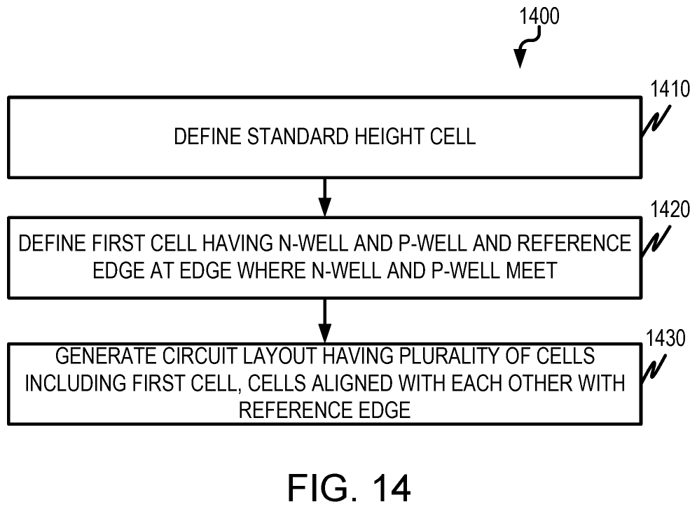

FIG. 14 is another exemplary flow chart 1400 illustrating a computer-implemented method of generating a library of standard cells in accordance with various embodiments of the present disclosure. A standard height cell is defined within a cell library such as cell repository 110 (e.g., step 1410). A first cell (e.g., cell 300) including an N-well (e.g., N-well 330) and a P-well (e.g., P-well 320) is defined within the cell library (e.g., step 1420). A reference edge such as reference edge 310 for the first cell (e.g., cell 300) is defined at an edge where the N-well (e.g., N-well 330) and the P-well (e.g., P-well 320) abut each other and wherein a total height of first cell (e.g., cell height 300c) is greater than or less than a total height of the standard height cell. The device layout such as device layout 1000 having a portion of the plurality of cells including the first cell (e.g., cell 300) is generated (e.g., step 1430). The reference edge of the first cell is aligned with a placement reference edge (e.g., placement reference edge 1032) in a row of the device layout.

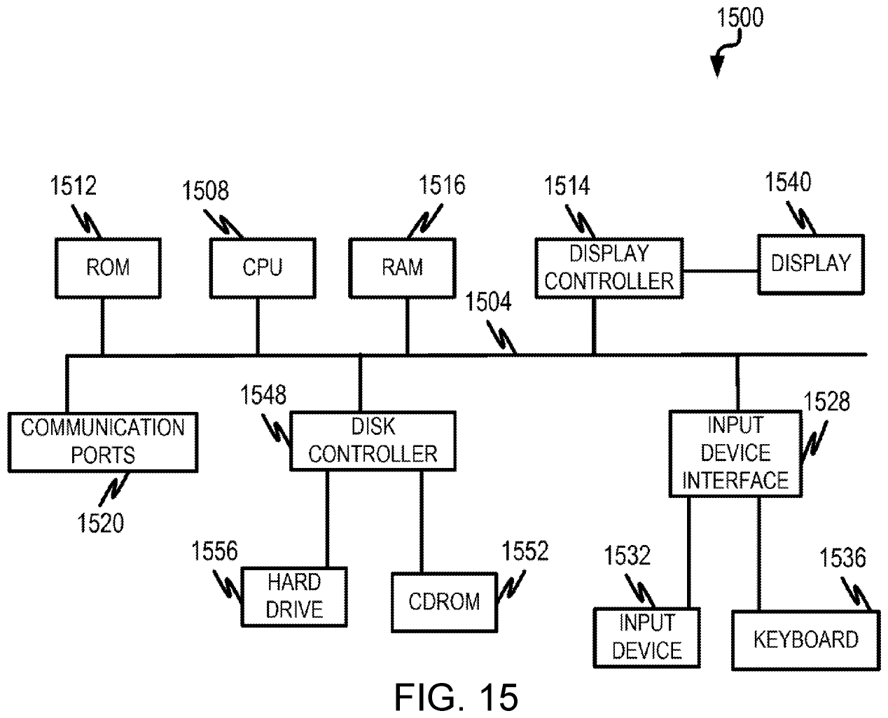

FIG. 15 is an exemplary block diagram 1500 illustrating a sample computing device architecture for implementing various aspects described herein. A bus 1504 can serve as the information highway interconnecting the other illustrated components of the hardware. A processing system 1008 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1512 and random access memory (RAM) 1516, can be in communication with the processing system 1508 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1548 can interface one or more optional disk drives to the system bus 1504. These disk drives can be external or internal CD-ROM, CD-R, CD-RW or DVD, or solid state drives such as 1552, or external or internal hard drives 1556. As indicated previously, these various disk drives 1552, 1556 and disk controllers are optional devices. The system bus 1504 can also include at least one communication port 1520 to allow for communication with external devices either physically connected to the computing system or available externally through a wired or wireless network. In some cases, the communication port 1520 includes or otherwise comprises a network interface.

To provide for interaction with a user, the subject matter described herein can be implemented on a computing device having a display device 1540 (e.g., a CRT (cathode ray tube) or LCD (liquid crystal display) monitor) for displaying information obtained from the bus 1504 to the user and an input device 1532 such as keyboard 1536 and/or a pointing device (e.g., a mouse or a trackball) and/or a touchscreen by which the user can provide input to the computer. Other kinds of input devices 1532 can be used to provide for interaction with a user as well; for example, feedback provided to the user can be any form of sensory feedback (e.g., visual feedback, auditory feedback by way of a microphone or tactile feedback); and input from the user can be received in any form, including acoustic, speech, or tactile input. In the input device 1532 and the keyboard 1536 can be coupled to and convey information via the bus 1504 by way of an input device interface 1528. Other computing devices, such as dedicated servers, can omit one or more of the display 1540 and display interface 1514, the input device 1532, the keyboard 1536, and input device interface 1528.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, Perl, Python, Tcls, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

Use of the various processes as described herein can provide a number of advantages. For example, use of the subject matter enables a high degree of flexibility in terms of cell height within the same cell library so that each cell can be independently optimized within a device layout design. This cell library, along with a placer, can place a plurality of cells in a Jigsaw puzzle format which can result in PPA benefits.

In one embodiment, a device layout having optimized cell placement includes a plurality of cells arranged in an area. Each cell includes a first cell region and a second cell region. The first cell region abuts the second cell region. A reference edge is defined where the first cell region abuts the second cell region. The device layout also includes a pair of power rails configured to provide power to the plurality of cells. The cells are aligned such that the reference edge of each cell is placed in alignment with the placement reference edge within the row that it is placed in.

In another embodiment, a computer-implemented method of optimizing a device layout having a plurality of cells includes defining, within a cell library comprising the plurality of cells, a standard height cell. A first cell having an N-well and a P-well is defined within the cell library. A reference edge for the first cell is defined at an edge where the N-well and the P-well abut each other. The total height of first cell is greater than or less than a total height of the standard height cell. A device layout having some or all of the plurality of cells including the first cell is generated using an EDA tool. The reference edge is aligned with a placement reference edge of a row having some of the plurality of cells.

In yet another embodiment, a cell is stored in a computer readable medium. The cell includes a first cell region and a second cell region. The first cell region and the second cell region abut at a reference edge.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A device having optimized cell placement comprising:
a plurality of cells arranged in an area placed in a plurality of rows, each cell comprising:
a first cell region; and
a second cell region abutting the first cell region, wherein a reference edge is defined where the first cell region and the second cell region abut each other,
wherein:
the reference edge of each cell is aligned with a placement reference edge of each row; and
heights of at least a portion of the cells along a single row vary in size in relation to the placement reference edge for at least a portion of the rows.

2. The device of claim 1, further comprising a pair of power rails configured to provide power to the plurality of cells, within each row a portion of the plurality of cells are arranged such that the reference edge is between the pair of power rails.

3. The device of claim 1, wherein cells of the plurality of cells is placed in a location of the device to minimize space between one or more adjacent cells.

4. The device of claim 1, wherein (i) the first cell region is an N-well and (ii) the second cell region is a P-well.

5. The device of claim 1, wherein (i) the first cell region and the second cell region form a skewed N cell and (ii) a height of the second cell region is greater than a height of the first cell region.

6. The device of claim 1, wherein (i) the first cell region and the second cell region form a cell and (ii) a height of the first cell region and a height of the second cell region are equal to each other.

7. The device of claim 1, wherein (i) the first cell region and the second cell region form a fractional height cell, (ii) a height of the first cell region and a height of the second cell region are equal to each other, and (iii) a height of a combination of the first cell region and the second cell region is a fraction of a height of a standard cell.

8. The device of claim 1, wherein (i) the first cell region and the second cell region form an elongated cell, (ii) a height of the first cell region and a height of the second cell region are equal to each other, and (iii) a height of a combination of the first cell region and the second cell region is greater than a height of a standard cell.

9. The device of claim 1, wherein (i) the first cell region and the second cell region form a split double height cell, (ii) the first cell region has a height at least double that of the height of a standard cell height, and (iii) a first portion of the second cell region is positioned above the first cell region and a second portion of the second cell region is positioned beneath the first cell region.

10. The device of claim 1, wherein (i) the first cell region and the second cell region form a double standard height cell and (i) a height of the first cell region is at least double a height of a standard cell, or (ii) a height of the second cell region is at least double the height of the standard cell.

11. The device of claim 1, wherein (i) the first cell region and the second cell region form a skewed P cell and (ii) a height of the first cell region is greater than a height of the second cell region.

12. The device of claim 1, wherein (i) the first cell region and the second cell region form a skewed P fractional cell and (ii) a height of the first cell region is a fraction of the second cell region.

13. A computer-implemented method of generating a device comprising a plurality of cells, the computer-implemented method comprising:
defining, within a cell library comprising the plurality of cells, a standard height cell;
defining, within the cell library, a first cell comprising an N-well and a P-well, wherein a reference edge for the first cell is defined at an edge where the N-well and the P-well abut each other and wherein a total height of first cell is greater than or less than a total height of the standard height cell; and
generating, using the cell library, the device comprising a portion of the plurality of cells including the first cell,
wherein:
the reference edge of the first cell is aligned with a placement reference edge in a row of the device; and
heights of at least a portion of the cells vary in size in relation to the placement reference edge for the row.

14. The computer-implemented method of claim 13, wherein the first cell comprises at least one of (i) a skewed N cell comprising a first P-well and a first N-well, wherein the first P-well has a corresponding height that is greater than a height of the first N-well, (ii) a cell comprising a second N-well and a second P-well, wherein a height of the second N-well and a height of the second P-well are equal, (iii) a fractional height cell comprising a third N-well and a third P-well, wherein a height of the third N-well and a height of the third P-well are equal, the height of the third N-well is less than the height of the second N-well, and the height of the third P-well is less than the height of the second P-well, (iv) an elongated cell comprising a fourth N-well and a fourth P-well, wherein a height of the fourth N-well is equal to a height of the fourth P-well, the height of the fourth N-well is less than the height of the second N-well, and the height of the fourth P-well is less than the height of the second P-well, (v) an N-only cell comprising a fifth N-well, (vi) a split double height cell comprising a sixth N-well having a height at least double that of the height of second N-well height and at least two P-wells surrounding each edge of the sixth N-well, or (vii) a double standard height cell comprising a seventh N-well and a sixth P-well, wherein a height of the seventh N-well is at least double the height of the second N-well and a height of the sixth P-well is at least double the height of the second P-well.

15. The computer-implemented method of claim 13, wherein the plurality of cells comprises at least one of (i) a P-only cell comprising a P-well extending vertically relative to the reference edge, (ii) a skewed P cell comprising a first N-well and a P-well, wherein a height of the first N-well is greater than a height of the P-well, or a skewed P fractional cell comprising a second N-well and a second P-well, wherein a height of the second N-well is a fraction of the second P-well.

16. The computer-implemented method of claim 13, wherein each cell of the plurality of cells is placed in a location of the device to minimize space between an adjacent cell.

17. The computer-implemented method of claim 13, wherein the first cell is aligned with the other cells with the reference edge being the center of each of the other cells in a row of cells.

18. The computer-implemented method of claim 13, wherein the portion of the cell extends in at least one of a vertical direction relative to the reference edge.

19. A device comprising:
a plurality of cells having varying heights, each cell comprising:
a first cell region; and
a second cell region positioned to abut the first cell region,
wherein a reference edge is defined where the first cell region and the second cell region abut each other for each of the cells.

20. The device of claim 19, wherein, for each cell, the first cell region comprises an N-well and the second cell region comprises a P-well.
